(19) United States
(12) Patent Application Publication
(10) Pub. No.: US 2009/0120590 A1
(43) Pub. Date: May 14, 2009

(54) Heating System, Heating and Laminarizing Method, Electrostatic Precipitator, Spray Dryer, Detaching Device and Method for Detaching Particles

(75) Inventors: Mathias Schon, Bazenheid (CH); Ralph Baumgartner, St. Gallen (CH)

Correspondence Address: SHOEMAKER AND MATTARE, LTD, 10 POST OFFICE ROAD - SUITE 100, SILVER SPRING, MD, 20910, US

(73) Assignee: BUCHI LABORTECHNIK AG, Flawil (CH)

(21) Appl. No.: 12/261,168

(22) Filed: Oct. 30, 2008

(30) Foreign Application Priority Data
Oct. 30, 2007 (EP) 07119615.8

(51) Int. Cl. B01D 1/18; H05B 3/02; B01D 1/30; B03C 3/34; B03C 3/88

(52) U.S. Cl. 159/4.04; 392/314; 96/83; 96/51; 95/74; 159/48.1; 159/3

(57) ABSTRACT

A heating system for a spray dryer has a heating element, a heating unit having an open-pore metal foam, and a fluid input and a fluid output. The metal foam is arranged between the fluid input and the fluid output so that fluid which flows in through the fluid input and out through the fluid output is laminarized. A method for simultaneously heating and laminarizing a fluid with the aid of an open-pore metal foam is also disclosed, as is an electrostatic precipitator having a sleeve-shaped electrode connected to a base part of the precipitator. Also disclosed is a device for detaching particles from an inner surface of a sleeve-shaped electrode, a method for detaching particles, and a spray dryer with a heating system as above and/or with an electrostatic precipitator.

The present invention relates to a heating system, to a method for simultaneously heating and laminarizing a fluid, to an electrostatic precipitator, to a spray dryer, to a detaching device, to a combination of an electrostatic precipitator and a detaching device, and also to a method for detaching particles according to the precharacterizing clauses of the independent patent claims.

Spray drying is a method which is known per se and which is used, for example, in order to obtain natural dyes, to isolate pharmaceutical active compounds or for microencapsulation. During spray drying, a spray material, for example a solution, emulsion, suspension or dispersion, is sprayed, for example by means of a nozzle, into a hot drying gas and dried as a result. The drying gas is usually heated electrically or separately by means of a gas- or oil-operated heating system. The solvent which is contained in the spray material and, for example, is water is evaporated by the drying gas. The particles which are therefore obtained and which may be present, for example, in the form of a powder, agglomerate or granular material are subsequently separated from the drying gas. This takes place, for example, with the aid of a sieve, an electrostatic precipitator or a cyclone. A spray dryer for carrying out spray drying is described, for example, in DE 40 28 341.

The electric heating systems used in known spray dryers require turbulence to be generated in the drying gas so that the drying gas comes into contact with a heating unit of the heating system and therefore a large transfer of heat to the fluid occurs. However, such turbulence also results in uncontrolled swirling of the spray material such that the latter, for example, may be deposited in an undesirable manner on the walls of the drying chamber. In addition, the distribution of heat within the heating unit and therefore also within the drying gas is not uniform, which results in a nonuniform formation of particles which can be difficult to control. Furthermore, conventional heating systems react relatively sluggishly to control of the power and temperature. Furthermore, conventional heating systems are disadvantageous because of their large overall size. Finally, there is a need to improve the transfer of heat from the heating unit to the drying gas.

It is therefore an object of the present invention to avoid the disadvantages of the known and in particular to provide a heating system for a spray dryer, which heating system avoids turbulence in the supplied drying gas.

Accordingly, a first aspect of the invention relates to a heating system, in particular for a spray dryer, with at least one heating element, at least one heating unit, and with a fluid input and a fluid output. The heating unit comprises an open-pore metal foam which is arranged between the fluid input and the fluid output. In this case, the fluid input and/or the fluid output can be formed in particular directly by one of the surfaces of the metal foam. The arrangement of the metal foam is selected in such a manner that a fluid which flows in through the fluid input and flows out through the fluid output is laminarized. The fluid may be a gas, in particular a drying gas in a spray dryer.

Metal foams per se are known, for example, from DE 199 39 155. Such metal foams are used, for example, in heat exchangers, such as, for example, in the one illustrated in DE 101 23 456. The arrangement of the metal foam in the heating system according to the invention causes a fluid which flows out of the fluid output to exit in the form of a laminar flow. By means of the heating element, the metal foam can be heated and can therefore also heat the fluid flowing through it. Owing to the large surface within the open-pore metal foam, a highly effective transfer of heat from the metal foam to the fluid occurs. A simultaneously hot and laminar fluid flow can therefore be obtained, surprisingly, by means of a single structural element. Furthermore, the metal foam also results in a uniform temperature distribution in the emerging fluid flow. Furthermore, such a metal foam is distinguished by a structural size which falls far short of that of a conventional electric heating system.

The heating element is preferably designed as an electric resistance heating element. The resistance heating element advantageously comprises a heating wire which in particular can be twisted. In contrast to known heat exchangers, in which a second fluid supplies the heat, in this embodiment there are far fewer losses, since the heating effect occurs directly in the heating element and therefore directly in or on the metal foam.

In a preferred embodiment, the heating element is directly connected to the metal foam, in particular pressed therein. There is thus a highly effective transfer of heat to the metal foam and therefore also to the fluid flowing through it. Furthermore, such a connection permits rapid adjustment of the temperature.

The metal foam preferably comprises aluminium. It particularly preferably comprises an aluminium alloy, in particular AlSi₇Mg. Furthermore preferably, the ratio of the pore volume to the overall volume is at least 60%, as a result of which a high through-flow capacity is obtained. Such a material per se is described, for example, in DE 103 36 657. The pore size likewise preferably lies within the range of between 0.1 mm and 4 mm, preferably between 0.2 mm and 2 mm, particularly preferably between 0.4 mm and 1.2 mm.

In one embodiment, the metal foam is arranged between two holding elements through which the fluid can flow. The metal foam is preferably held between the two holding elements. The holding elements may in particularly be grids. Such grids make it possible to simultaneously hold the metal foam and to allow the fluid to flow through.

Furthermore, the invention relates to a spray dryer with a heating system having an open-pore metal foam, in particular a heating system as described above. In addition to the heating system, a spray dryer of this type comprises at least one drying chamber and an outlet opening for the spray material, for example in the form of a nozzle, and an outlet opening for the drying gas.

The heating system according to the invention is arranged in such a manner that a drying gas can flow in the fluid input and can flow out of the fluid output and can flow from there out of the outlet opening into the drying chamber. The fluid output of the heating system is particularly preferably arranged directly at the drying chamber. In this way, turbulence is not produced between the heating system and the drying chamber. Furthermore, preferably, the heating system is designed and arranged in such a manner that the laminarized drying gas flows out of the fluid output substantially in a direction which corresponds to the direction in which the spray material flows out. By this means, turbulence is avoided, and therefore the drying can take place under controlled conditions and the spray material and/or the particles produced are not deposited at undesirable locations.

Furthermore, the spray dryer can comprise feed lines for the spray material, feed lines for the drying gas, filters, means for treatment of the exhaust gas, an operating device for the heating system and/or the feed lines and/or support material. Furthermore, it can contain means for collecting the agglomerated particles or a powder produced, such as, for example, an electro-static precipitator, a sieve or a cyclone. Owing to its dimensions, the spray dryer is preferably suitable for use in a laboratory. Its weight is typically less than approximately 100 kg, and its typical overall height is less than approximately 2 m. The drying chamber typically has a horizontal extent of at most 50 cm, preferably at most 25 cm.

The present invention furthermore relates to a method for simultaneously heating and laminarizing a fluid, wherein the fluid flows through an open-pore metal foam. The fluid can be a gas, in particular a drying gas in a spray dryer. One embodiment of the method provides the use of an open-pore metal foam in a spray dryer, in which a drying gas is heated and is simultaneously laminarized by means of the metal foam before it enters a drying chamber. In this case, the metal foam may be arranged in a heating system according to the invention.

A further aspect of the invention relates to an electrostatic precipitator which can be used in particular in a spray dryer. In an electrostatic precipitator of this type, particles, for example particles obtained during spray drying, can be charged in an electric field and subsequently deposited on an electrode.

A plurality of mechanisms are known, by means of which the particles therefore deposited can be detached from the electrode and collected. The particles may be collected, for example, purely mechanically, such as, for example, by stripping or shaking, by sound or ultrasound, reversing the polarity of the electrodes or by rinsing off with a liquid. A device for collecting dirt particles in an electrostatic precipitator is known, for example, from U.S. Pat. No. 5,437,713. The precipitator contains plate-electrodes from which the particles are collected by stripping. However, the construction illustrated in said document is mechanically highly complicated, since the strippers have to be introduced between the electrodes located in the precipitator.

This and further disadvantages are overcome by means of the electrostatic precipitator proposed here. The precipitator according to the invention has at least one electrode which in particular can be of sleeve-shaped design. According to the invention, this electrode is connected or can be connected releasably to a base part of the precipitator. Owing to this releasable connectability of the electrode to the base part, it is possible to remove the electrode for cleaning and/or for detaching particles deposited thereon. Furthermore, it is possible to operate the precipitator in an alternating manner with a plurality of electrodes, in particular electrodes which differ from one another, or else, for example, to exchange defective electrodes.

The electrode is advantageously connected to the base part in such a manner that it can be drawn out of the base part of the precipitator. This permits particularly simple detachment of the electrode. The electrode can particularly preferably be separated from the base part exclusively by means of a tensile force. Further steps, such as, for example, the release of screws, are therefore unnecessary. Furthermore preferably, the electrode can be connected releasably to the base part of the precipitator by being pressed in. Particularly preferably, only a compressive force is necessary for the connection. Further steps, such as, for example, the tightening of screws, are therefore unnecessary.

According to a preferred embodiment, the electrode is of sleeve-shaped design, and the precipitator comprises a counter electrode which has a multiplicity of radially outwardly directed points. In this case, the counter electrode is arranged within the electrode at least in a connecting position in which the electrode and the base part of the precipitator are connected to each other. Points of this type generate high local electric field strengths, which results in the particles flowing through them being charged. The points can be arranged, for example, on a side edge of a metal strip which is arranged on the casing surface of a cylinder. The metal strip here can be coiled, for example spirally, or can be arranged in the form of a plurality of rings. The points can be formed, for example, as serrations of approximately triangular portions punched out of the metal strip. One such electrode per se is described in DE 20 2005 018 606.

The base part of the precipitator advantageously has a plug-in receptacle into which the electrode can be plugged releasably, in particular in the axial direction. In particular in the case of a sleeve-shaped electrode, said electrode can be plugged in the direction of its longitudinal axis.

In a preferred embodiment, the sleeve-shaped electrode can be separated in the direction of its longitudinal axis from the base part of the precipitator. In this case, the sleeve-shaped electrode can preferably be connected to the base part in such a manner that it can be separated therefrom without a counter electrode having to be separated from the base part. This permits particularly simple removal of the electrode, for example for cleaning purposes, without complete disassembly of the precipitator.

The plug-in receptacle particularly preferably has electric contacts which can be earthed. This makes it possible for the electrode to be brought directly into connection with the electric contacts by being plugged in. Further steps for applying contacts are therefore not necessary. The electric contacts are preferably designed as spring contacts, which permits particularly simple handling.

The base part preferably has a cable channel which contains at least one cable for acting upon the electrode and/or the counter electrode with an electric potential. An electric potential is always also understood here and below to be a zero potential, i.e. a connection to earth. The cable is particularly preferably encapsulated in the cable channel.

A further aspect of the invention relates to a spray dryer with an electrostatic precipitator, in particular an electrostatic precipitator as described above, which has at least one electrode and at least one counter electrode. The spray dryer can furthermore contain one or more of the abovementioned components.

According to the invention, the precipitator can be brought relative to the spray dryer either into an operating position or into a removal position. In the operating position, the electrodes and counter electrodes of the precipitator can each be acted upon with an electric potential. In the removal position, at least one electrode of the precipitator is separated or can be separated from the spray dryer. In particular, the entire precipitator can be separated from the spray dryer in the removal position.

The electrostatic precipitator of the spray dryer can in particular be a precipitator according to the invention.

Such a construction makes it possible to remove at least one electrode of the precipitator from the spray dryer, for example to clean the latter and/or to detach particles therefrom, and to subsequently insert the electrode again into the spray dryer.

In one embodiment, the precipitator is transferred from the operating position into the removal position by being moved relative to the spray dryer in a direction which is substantially parallel to a longitudinal axis of the electrode.

The spray dryer preferably has an actuating device by means of which the precipitator can be brought directly or indirectly either into the operating position or into the removal position. The actuating device can particularly preferably be operated one-handed. This permits the transfer in a simple manner of the precipitator into a position in which at least one electrode can be separated from the precipitator.

According to one embodiment, the actuating device comprises an actuating lever which can be rotated and/or displaced relative to the spray dryer. By this means, particularly simple operation is achieved.

According to one embodiment, the precipitator can be separated in the removal position from the spray dryer in a removal direction which is substantially perpendicular to a longitudinal axis of the electrode. In particular in the case of spray dryers which are of elongated design and in which the electrode is oriented along the longitudinal direction of the spray dryer, this mechanism ensures simple removal of the electrode.

According to a further preferred embodiment, the electrode of the precipitator can be separated from the base part of the precipitator in the removal position. This permits the transfer of the precipitator first of all into the removal position and subsequently the separation of the electrode from the base part.

Furthermore, the invention relates to a detaching device for detaching particles from an inner surface of a sleeve-shaped electrode, in particular a sleeve-shaped electrode as described above. The detaching device has stripping means for stripping the particles from the inner surface. The electrode may be the electrode of an electrostatic precipitator according to the invention. The detaching device makes it possible for particles which have been deposited during the electrostatic precipitation to be detached mechanically and in particular to be collected.

According to a preferred embodiment, the stripping means are arranged rotatably about an axis of rotation. This axis of rotation can be oriented in such a manner that it coincides with a longitudinal axis of the electrode or is substantially parallel thereto. This permits stripping in a direction which lies substantially perpendicular to the longitudinal axis of the electrode. By this means, in contrast to stripping means which only permit stripping parallel to the longitudinal axis of the electrode, a low construction height during the stripping operation is obtained.

The stripping means are preferably connected rotatably to a cover which can be connected releasably to the electrode. In particular, the cover can be placed onto the electrode in a form-fitting manner. Tilting of the axis of rotation in relation to the longitudinal axis of the electrode is therefore prevented, which increases the stability during the stripping operation and therefore simplifies the handling.

The stripping means preferably comprise at least one in particular elastic strip with a stripping edge. Said stripping edge is substantially parallel to the axis of rotation of the electrode and can be brought into contact with the inner surface of the electrode. In particular, the stripping edge is designed in such a manner that it can be brought over its entire length into contact with the electrode. As an alternative or in addition, the stripping edge is designed in such a manner that it can be brought into contact with the inner surface substantially along the entire axial length of the electrode. This guarantees particularly effective stripping, since the entire inner surface of the electrode can be traversed with a single revolution of the strip.

The detaching device can additionally contain collecting means for collecting the particles which have been stripped off. Said collecting means may comprise, for example, a funnel, the opening of which is matched to the shape and size of the electrode. The collecting means can particularly preferably be connected to the electrode in a form-fitting manner. This prevents tilting of the electrode in relation to the collecting means, in particular during movement of the stripping means, and also prevents the loss of particles.

Furthermore, the collecting means can have a collecting container which in particular is arranged or can be arranged below the funnel. In particular, the collecting container can be connected to the funnel in a form-fitting manner. This also increases the stability of the detaching device, in particular during movement of the stripping means.

A further aspect of the invention relates to a combination which comprises an electrostatic precipitator according to the invention and a detaching device according to the invention. In this case, the shape and size of the detaching device and of the at least one electrode of the electrostatic precipitator are coordinated with each other in such a manner that particles can be detached from an inner surface of the electrode by means of the detaching device. This combination makes it possible for the particles to first of all be deposited in the precipitator and for them to be subsequently collected with the aid of the detaching device.

Furthermore, the combination may also comprise a spray dryer which contains the electrostatic precipitator. In particular, it may be a spray dryer as described above. Overall, this combination makes it possible to produce particles by means of spray drying, to deposit them and subsequently to collect them.

Finally, the invention relates to a method for detaching particles from an inner surface of a sleeve-shaped electrode of an electrostatic precipitator, in particular an electrostatic precipitator according to the invention. The method contains the following steps:

removing the electrode from the precipitator,
detaching particles from the inner surface of the electrode.

In particular, a detaching device according to the invention can be used to detach the particles.

According to a development of the method, the electrostatic precipitator used can be contained in a spray dryer according to the invention. The method then also comprises in particular the production of the particles in the spray dryer.

The invention is explained in more detail below with reference to an exemplary embodiment and drawings, in which:

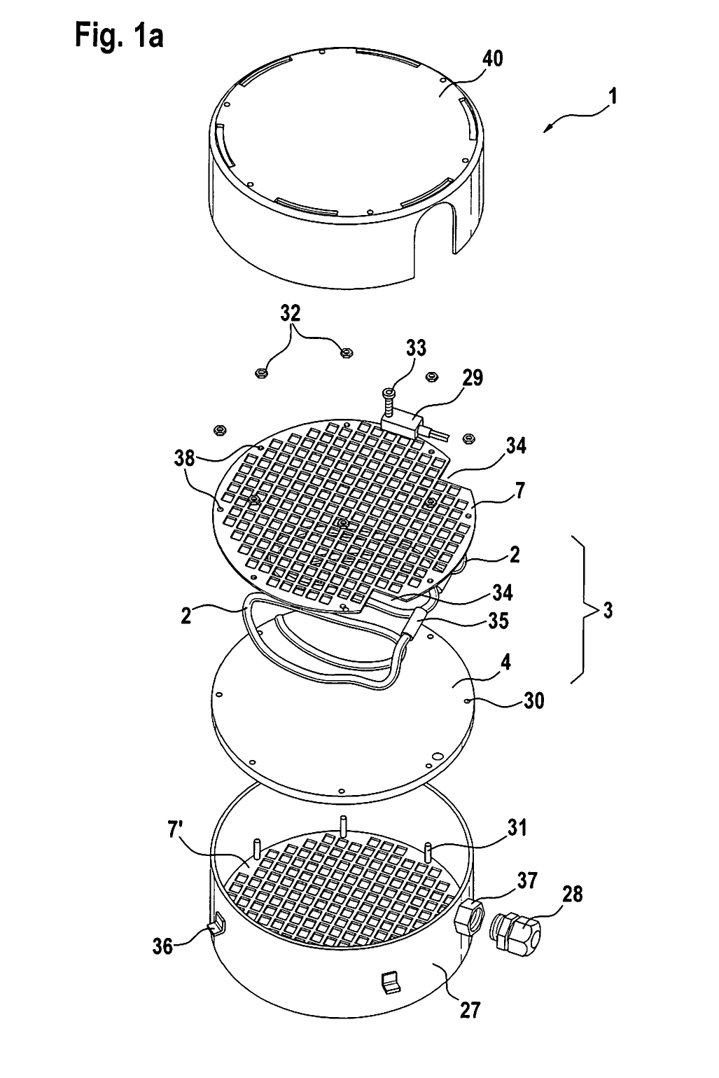

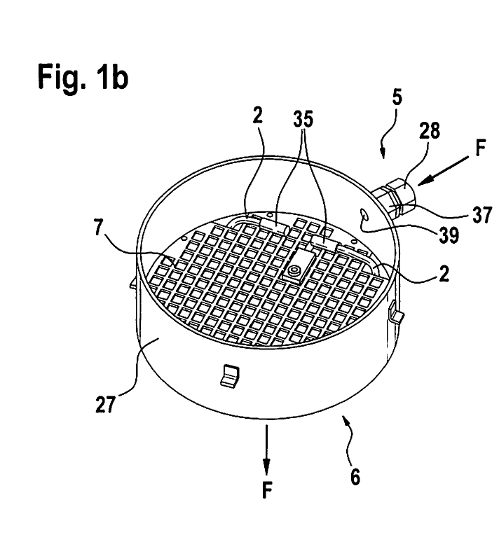

FIG. 1a shows an exploded illustration of a heating system according to the invention;

FIG. 1b shows a perspective top view of the heating system according to FIG. 1a;

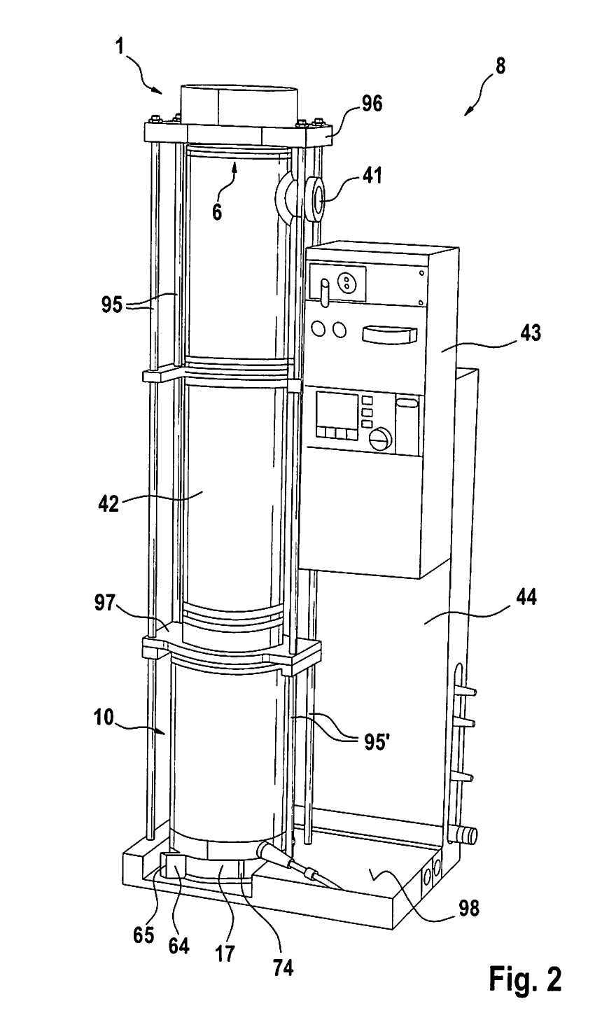

FIG. 2 shows a spray dryer according to the invention with a heating system according to the invention;

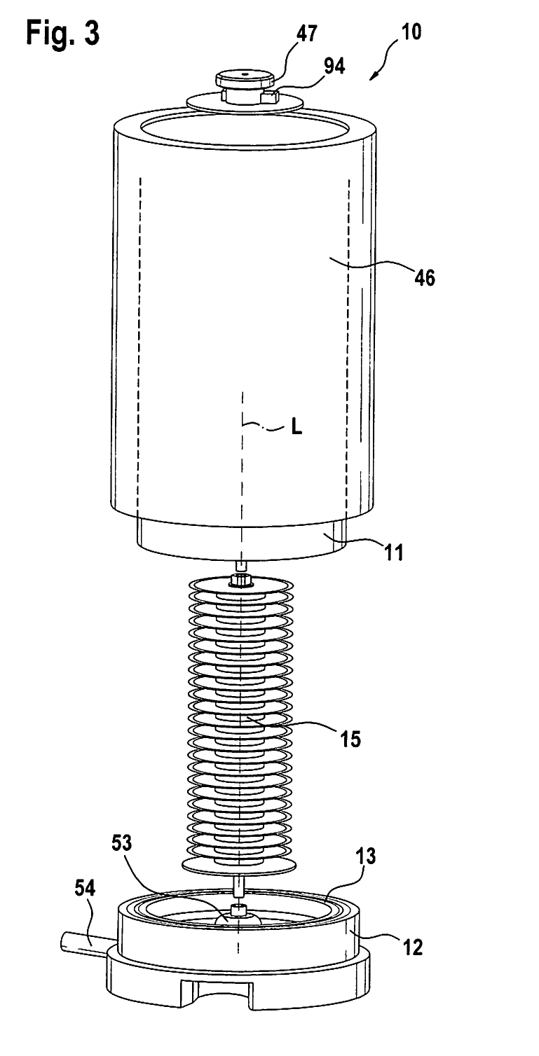

FIG. 3 shows an electrostatic precipitator according to the invention;

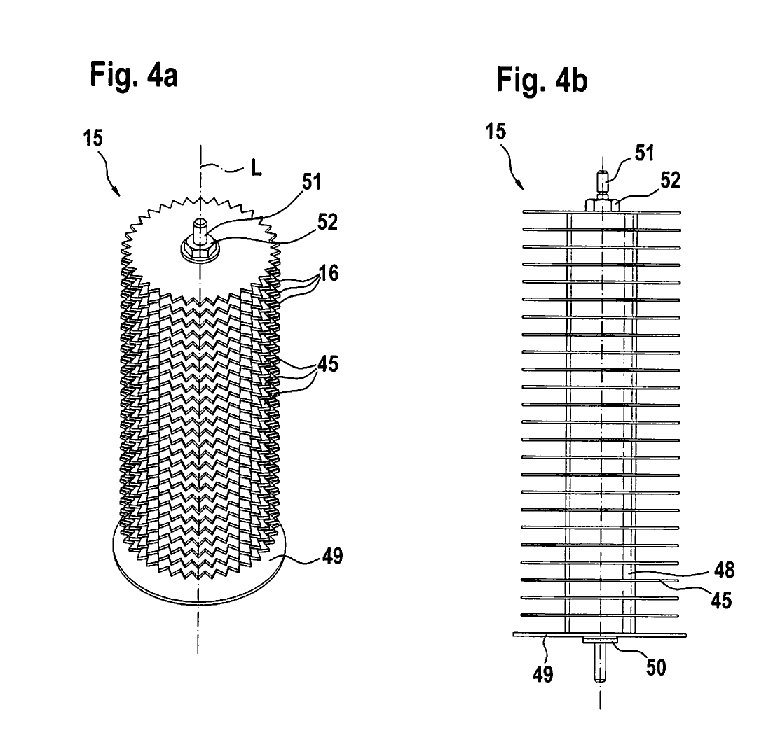

FIG. 4a shows a perspective view of the counter electrode of the electrostatic precipitator according to FIG. 3;

FIG. 4b shows a side view of the counter electrode according to FIG. 4a;

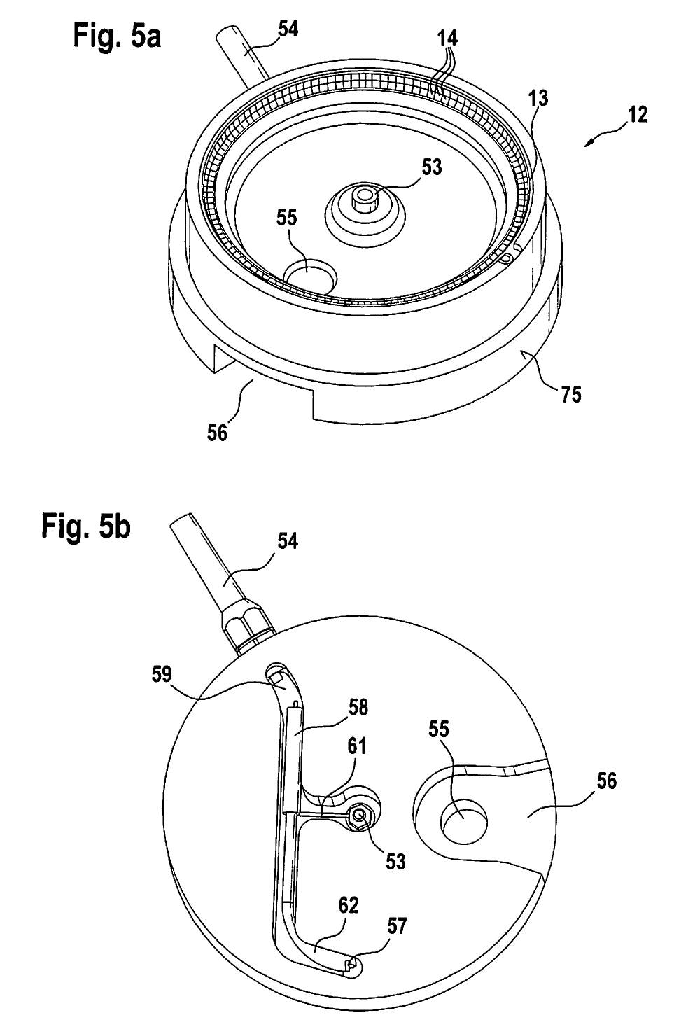

FIG. 5a shows a perspective view of the upper side of the base part of the electrostatic precipitator according to FIG. 3;

FIG. 5b shows a perspective view of the lower side of the base part according to FIG. 5a;

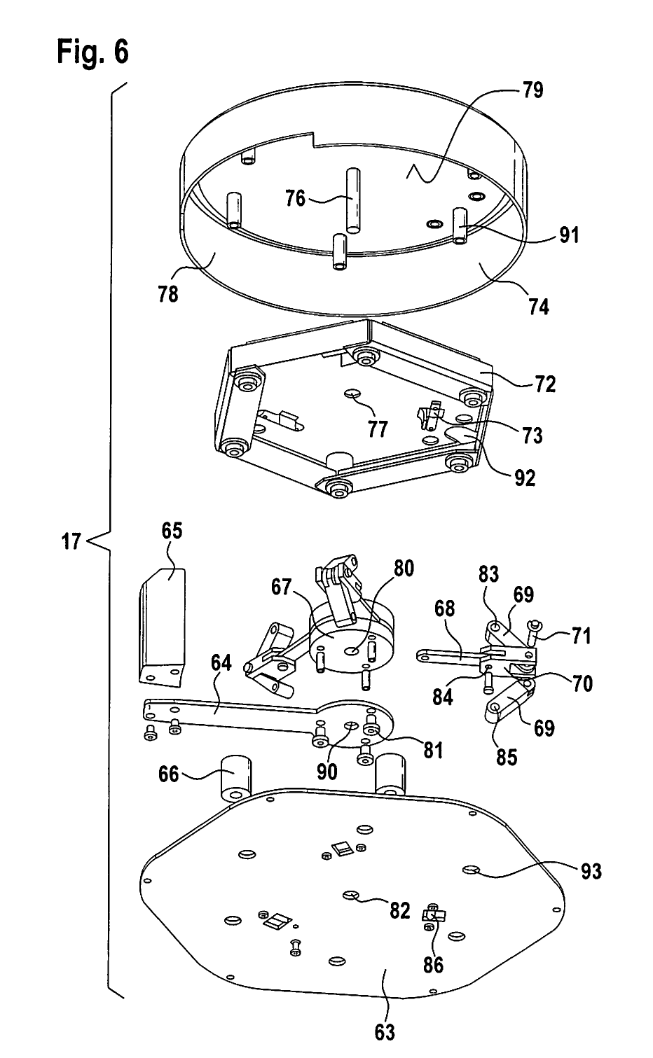

FIG. 6 shows an actuating device for a spray dryer according to the invention;

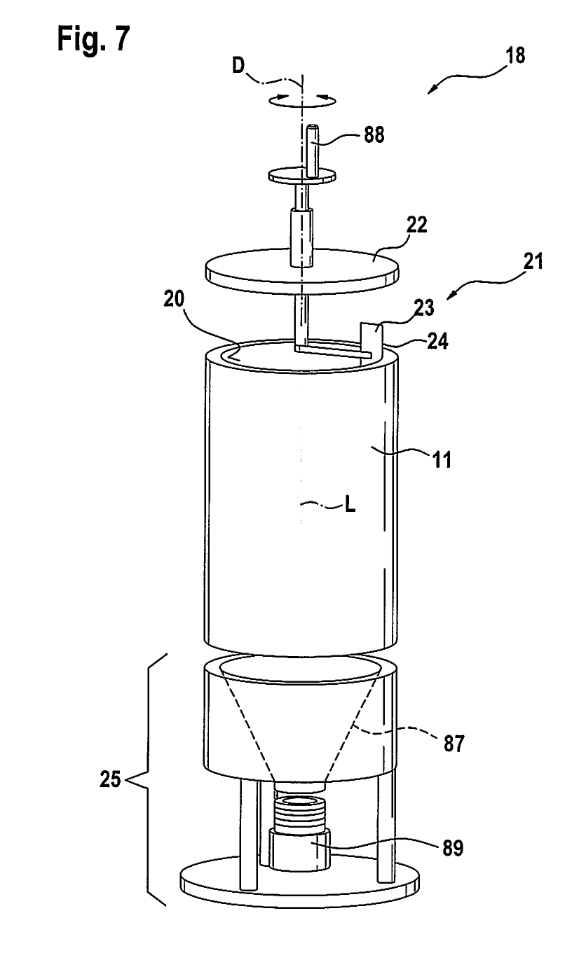

FIG. 7 shows a detaching device according to the invention.

FIGS. 1a and 1b illustrate a heating system 1 according to the invention. The heating system 1 contains two heating elements which are designed as cable heating elements 2. The cable heating elements 2 each contain at least one in particular twisted heating wire which is heated when an electric current flows through it. The heating system 1 furthermore comprises a heating unit 3 which is designed as an open-pore metal foam 4. The metal foam 4 is composed of an aluminium alloy AlSi₇Mg and can be obtained from m-pore GmbH, 01277 Dresden, Germany. The metal foam 4 is substantially in the shape of a circular disc and has a diameter of 160 to 200 mm and a thickness of 10 mm.

The cable heating elements 2 have been obtained from Watlow GmbH, 76709 Kronau, Germany. They are pressed into the metal foam 4 and can be connected to a voltage supply (not illustrated here). When a voltage of 115 V is applied, the two cable heating elements 2 each supply a power of 300 W. With said cable heating elements 2, heating of the metal foam 4 to a homogenous operating temperature of 120° C. is possible within 5 minutes. At their ends, the cable heating elements 2 are provided with mechanical strain-relief means 35.

The heating unit 3, which comprises the metal foam 4 and the cable heating elements 2 pressed therein, is held between two grids 7, 7′ which are substantially likewise in the shape of circular discs. The upper grid 7 has two notches 34 through each of which one of the cable heating elements 2 is guided. Press-in bolts 31 which penetrate fixing openings 30 in the metal foam 4 and fixing openings 38 in the upper grid 7 are arranged on the lower grid 7′. The heating unit 3 is held between the two grids 7, 7′ by means of nuts 32 which are placed onto the press-in bolts 31. The entity comprising heating unit 3 and grids 7, 7′ is held in a sleeve-shaped casing 27, on the upper side of which a covering 40 is arranged. Furthermore, angle brackets 36 by means of which the heating system 1 can be fastened, for example, in a spray dryer are arranged on the outer surface of the casing 27.

A connecting nut 37 which is connected to an aperture 39 in the casing 27 and can be connected to a screwed cable gland 28 is arranged on the outside of the casing 27. The connecting nut 37 forms a fluid input 5 of the heating system 1. A fluid output 6 of the heating system 1 is formed by the lower grid 7′. The configuration of the heating system 1 makes it possible for a fluid F, which flows into the heating system 1 through the connecting nut 37 which forms the fluid input 5, to be simultaneously heated and laminarized by the metal foam 4 and to subsequently be able to flow out of the heating system 1 through the lower grid 7′ which forms the fluid output 6.

Furthermore, the heating system 1 has an overtemperature protector 29 with a temperature sensor which is fastened to the upper grid 7 with the aid of a screw 33.

FIG. 2 illustrates a spray dryer 8 according to the invention. The spray dryer 8 comprises a framework 44 with tie rods 95, 95′, an end plate 96 and an intermediate plate 97. By means of the upper tie rods 95, a drying chamber 42 which is delimited by sleeve-shaped glass is clamped between the end plate 96 and the intermediate plate 97. The intermediate plate 97, for its part, is fastened above a base surface 98 of the framework by means of lower tie rods 95′. The drying chamber 42 has a diameter within the range of 160 to 200 mm. Spray material can be introduced into the drying chamber 42 through a spray material inlet 41 and a nozzle (not illustrated here). The heating system 1 which is described above and which contains the metal foam (which cannot be seen here) is arranged at the upper end of the drying chamber 42. A drying gas can flow into the heating system 1 through the fluid input (not illustrated here), can be heated and simultaneously laminarized by the metal foam and can subsequently leave the heating system 1 through the fluid output 6 which is arranged directly at the upper end of the drying chamber 42.

In one operating mode, air (i.e. a mixture of N₂ and O₂) with an optional and variably adjustable portion of CO₂ or an inert gas is used as the drying gas. According to another operating mode, an O₂-free mixture, in particular a mixture which contains N₂ and CO₂, is used as the drying gas. By avoiding O₂, ozone (O₃) which, due to its oxidizing effect, could destroy the particles produced is prevented from being generated in the electric field of an electrostatic precipitator.

The spray material dried by the drying gas can flow through the drying chamber 42 and pass into an electrostatic precipitator 10 which is arranged below the drying chamber 42 and the intermediate plate 97. Also arranged on the framework 44 is an operating device 43 by means of which, for example, the parameters of the heating system 1, the supply of the spray material and/or of the electrostatic precipitator 10 can be controlled.

The precipitator 10 is arranged on an actuating device 17. The actuating device 17 comprises an actuating lever 64 which can be rotated about a vertical axis. A grip 65 is arranged at the end of the actuating lever 64. By rotation of the actuating lever 64 about the vertical axis, a supporting plate 74 of the actuating device 17 can be moved in the vertical direction (cf. FIG. 6, bottom). The precipitator 10 can thereby be brought either into an operating position or into a removal position. In the operating position, which corresponds to the higher vertical position of the precipitator 10, the electrodes of the precipitator 10 can each be acted upon with an electric potential. In the removal position, which corresponds to the lower vertical position of the precipitator 10, the precipitator 10 can be separated from the spray dryer 8 in a horizontal direction, i.e. by lateral removal. In this removal position, the upper end of the precipitator 10 is no longer in contact with the intermediate plate 97 and the lower end of the drying chamber 42. The terms “horizontal” and “vertical” refer here and below to the precipitator 10 in the correct operating position, i.e. when it stands with the framework 44 on a horizontal plane.

FIG. 3 illustrates the electrostatic precipitator 10 according to the invention. The precipitator 10 has a base part 12 which contains a plug-in receptacle 13 on its upper side. The plug-in receptacle 13 has electric contacts which are designed as a multiplicity of spring contacts (see FIGS. 5a, b, bottom) and which can be brought to a certain electric potential, in particular can be earthed. Furthermore, the precipitator 10 comprises a sleeve-shaped, metallic electrode 11 which can be connected to the plug-in receptacle 13 of the base part 12 by means of a compressive force. The electrode 11 can then simply be drawn out of the plug-in receptacle 13 of the base part 12 again. In this case, the base part 12 and the electrode 11 are coordinated with each other in such a manner that the electrode 11 can be separated by a movement along its longitudinal axis L from the base part 12.

In the centre of its upper side, the base part 12 furthermore has a counter electrode contact 53 which can be acted upon with a high voltage and can be connected to a counter electrode 15. In a connecting position, in which the electrode 11 and the base part 12 of the precipitator 10 are connected to each other, the counter electrode 15 is arranged within the electrode 11.

The counter electrode 15 can be connected to the counter electrode contact 53 or can be released therefrom by means of a handle 47. The handle 47 has a rapid-action fastener 94, by means of which the handle 47 can be brought into a releasable form-fitting connection with the counter electrode 15 and therefore permits the counter electrode 15 to be grasped. Before the precipitator 10 is inserted into the spray dryer 8, the handle 47 is removed from the counter electrode 15.

The precipitator 10 furthermore has a sleeve-shaped precipitator casing 46 which laterally surrounds the electrode 11 and ensures electric and thermal insulation. The precipitator casing 46 consists of a polyurethane foam and has a radial thickness of approximately 20 mm. Furthermore, a screwed cable gland 54 is arranged laterally on the base part 12, by means of which gland the spring contacts and the counter electrode contact 53 can be acted upon with a high voltage (cf. FIGS. 5a, b, bottom).

The construction illustrated in FIG. 3 makes it possible for the electrode 11 to be separated from the base part 12 of the precipitator 10 without the counter electrode 15 having to be separated from the base part 12. This permits particularly simple removal of the electrode 11.

FIGS. 4a, b illustrate the counter electrode 15 contained in the precipitator 10 from FIG. 3. The counter electrode 15 has a rod-shaped central contact 51 on which star-shaped, metallic discs 45 and spacer rings 48 are arranged in an alternating manner. The star-shaped discs 45 have, on the outer circumference, a multiplicity of radially outwardly directed points 16. A supporting disc 49 is arranged in the vicinity of the lower end of the central contact 51, said supporting disc being held on its lower side by a stop ring 50 and supporting the star-shaped discs 45 and spacer rings 48 arranged above it. In the vicinity of the upper end of the central contact 51, the star-shaped discs 45 and the spacer rings 48 are held by a nut 52.

The base part 12 of the precipitator 10, which base part consists of polypropylene, is illustrated separately in FIGS. 5a, b. The plug-in receptacle 13 is arranged within the multiplicity of spring contacts 14. An outlet opening 55 passes through the base part 12 from its upper side to a cutout 56 on its lower side. The cutout 56 opens out at the outer circumference 75 of the base part 12. When the precipitator is used in a spray dryer, said outlet opening 55 serves to conduct out the drying gas. FIG. 5b shows the lower side of the base part 12 in a state in which it is not yet finished. The screwed cable gland 54 is connected to a cable channel 59 which is being milled into the interior of the base part 12. The cable channel 59 contains a cable 58, one strand 61 of which is connected to the counter electrode contact and the other strand 62 of which is connected at a contact point 57 to the spring contacts 14. In order to finish the base part 12, the cable channel 59 is encapsulated after the cable 58 is inserted.

FIG. 6 illustrates an actuating device 17 in a spray dryer, by means of which a precipitator can be brought into an operating position or into a removal position. The actuating device 17 comprises a base plate 63, an actuating lever 64, a rotatable part 67, an intermediate plate 72 and a supporting plate 74.

Three levers 70 are connected rotatably by means of a respective connecting tab 68 to the rotatable part 67. The connecting tabs 68, for their part, are connected rotatably to the levers 70 via joints 84. Each of the three levers 70 has a toggle lever 69 which is directed upwards and a toggle lever 69 which is directed downwards. Both toggle levers 69 can be rotated about a pin 71 about an axis lying in the horizontal. The actuating lever 64 is fastened to the rotatable part 67 by means of three screws 81. A handle 65 is arranged at the end of the actuating lever 64.

Dampers 66 are arranged above the base plate 63. the lower toggle levers 69 in each case have a bore 85 by means of which they are connected rotatably to pins 86 on the base plate 63, the axes of which pins lie in the horizontal. Three pins 73, the axes of which likewise lie in the horizontal, are arranged on the lower side of the intermediate plate 72. The upper toggle levers 69 in each case have bores 83 by means of which they are each connected rotatably to one of the pins 73.

The supporting plate 74 has a sleeve-shaped casing 78 and a circular supporting surface 79, from the lower side of which a central pin 76 and six outer pins 91 protrude. The intermediate plate 72, the rotatable part 67, the three levers 70 and the dampers 66 penetrate the interior of the supporting plate 74 and are surrounded by the casing 78 thereof. The intermediate plate 72, the rotatable part 67, the actuating lever 64 and the base plate 63 each have a central opening 77, 67, 90 or 82 through which the pin 76 is inserted. This connection permits vertical guidance of the rotatable part 67, the intermediate plate 72 and the supporting plate 74 relative to the base plate 63 and a rotatable mounting of the rotatable part 67 about the vertically oriented axis of the central pin 76. In addition, the intermediate plate 72 and the base plate 63 each have six outer openings 92 and 93, respectively, through which the outer pins 91 are inserted. This connection prevents rotation of the intermediate plate 72 and of the supporting plate 74 relative to the base plate 63.

For one-handed actuation of the actuating device 17, the actuating lever 64 is rotated about the pin 76 using the grip 65. This also causes rotation of the rotatable part 67 about the pin 76. The manner in which the toggle levers 69 are connected to the base plate 63 and to the intermediate plate 72 prevents the levers 70 from rotating about the axis of rotation defined by the central pin 76. Instead, the joints 84 are moved in the radial direction towards or away from the axis of rotation. This movement is made possible by the rotatability of the connecting tabs 68 relative to the rotatable part 67, the rotatability on the joints 84, the rotatability of the toggle levers 69 relative to the levers 70 and the rotatability of the lower toggle levers 69 in each case relative to the intermediate plate 72. As a result of this movement, the toggle levers 69 are rotated relative to the levers 70 such that the base plate 63 is moved in a vertical direction relative to the supporting plate 74. The guidance brought about by the central pin 76 and the outer pins 91 prevents the supporting plate 74 from rotating at the same time relative to the base plate 63. The dampers 66 bring about cushioning of said vertical movement.

The dampers 66 consist of rubber or plastic. The remaining individual parts of the actuating device 17 consist of stainless high-grade steel or aluminium.

For use in a spray dryer 8 according to the invention with a precipitator 10, the precipitator 10 is placed on the upper side of the supporting plate 74. In order to remove the electrode 11 from the spray dryer 8, the following steps are carried out:

transferring the precipitator 10 relative to the spray dryer 8 into a removal position, in particular by lowering the supporting plate 74, and in particular by operating the actuating device 17;
laterally removing the precipitator 10 from the spray dryer 8;
removing the electrode 11 from the precipitator 10.

FIG. 7 illustrates a detaching device 18 according to the invention for detaching particles from an inner surface 20 of a sleeve-shaped electrode 11. The detaching device 18 contains stripping means 21 which are arranged rotatably about an axis of rotation D which is parallel to a longitudinal axis L of the electrode 11. The stripping means 21 have an elastic strip 23 with a stripping edge 24. Said stripping edge 24 is substantially parallel to the longitudinal axis L of the electrode 11 and can be brought into contact with the inner surface 20 of the electrode 11. The stripping means 21 are connected rotatably to a cover 22 which can be placed onto the electrode 11 in a form-fitting manner.

Furthermore, the detaching device 18 has collecting means 25 for collecting the particles which have been stripped off, the collecting means comprising a funnel 87 and being connectable to the electrode 11 in a form-fitting manner.

In order to detach particles from the inner surface 20 of the sleeve-shaped electrode 11 of an electrostatic precipitator, the electrode 11 is first of all removed from the precipitator. The electrode 11 is subsequently placed onto the collecting means 25. The cover 22 is subsequently placed onto the electrode in such a manner that the strips 23 come into contact with the inner surface 20 of the electrode 11. To detach the particles from the inner surface 20, the strip 23 is rotated about the axis of rotation D relative to the cover 22 and therefore also relative to the electrode 11 by means of a crank 88. The particles stripped from the inner surface 20 by this means then fall into the funnel 87 and from there into a collecting container 89 arranged therebelow.

1. Heating system with at least one heating element, at least one heating unit which comprises an open-pore metal foam, and with a fluid input and a fluid output, wherein the metal foam is arranged between the fluid input and the fluid output in such a manner that a fluid which flows in through the fluid input and flows out through the fluid output is laminarized by means of the metal foam.

2. Heating system according to claim 1,
wherein the heating element is designed as an electric resistance heating element.

3. Heating system according to claim 1,
wherein the heating element is directly connected to the metal foam.

4. Heating system according to claim 1,
wherein the metal foam is arranged between two holding elements through which the fluid can flow.

5. Spray dryer with a heating system which contains a heating unit which comprises an open-pore metal foam.

6. Method for simultaneously heating and laminarizing a fluid, wherein the fluid flows through an open-pore metal foam.

7. Electrostatic precipitator with at least one electrode,
wherein the electrode is connected or can be connected releasably to a base part of the precipitator.

8. Electrostatic precipitator according to claim 7,
wherein the electrode can be connected to the base part in such a manner that it can be pulled out of the base part of the precipitator and can be connected releasably to the base part of the precipitator by being pushed in.

9. Electrostatic precipitator according to claim 7,
wherein the base part of the precipitator has a plug-in receptacle into which the electrode can be plugged releasably.

10. Electrostatic precipitator according to claim 9,
wherein the plug-in receptacle has electric contacts.

11. Electrostatic precipitator according to claim 7,
wherein the electrode has a longitudinal axis and can be separated in the direction of said longitudinal axis from the base part of the precipitator.

12. Electrostatic precipitator according to claim 7,
further containing a cable channel which contains at least one cable for supplying the electrode and the counter electrode with an electric potential, with the cable being encapsulated in the cable channel.

13. Spray dryer containing an electrostatic precipitator with at least one electrode and at least one counter electrode,
wherein
the precipitator can be brought relative to the spray dryer into an operating position and into a removal position,
the electrodes and counter electrodes of the precipitator can each be supplied with an electric potential in the operating position, and
at least one electrode of the precipitator is separated or can be separated from the spray dryer in the removal position.

14. Spray dryer according to claim 13,
further containing an actuating device by means of which the precipitator can be brought directly or indirectly either into the operating position or into the removal position.

15. Spray dryer according to claim 14,
wherein the actuating device comprises an actuating lever which is arranged rotatably or displaceably relative to the spray dryer.

16. Detaching device for detaching particles from an inner surface of a sleeve-shaped electrode, wherein the detaching device contains stripping means for stripping the particles from the inner surface.

17. Detaching device according to claim 16,
wherein the stripping means are arranged rotatably about an axis of rotation which can be oriented in such a manner that it coincides with a longitudinal axis of the electrode or is substantially parallel thereto.

18. Detaching device according to claim 16,
wherein the stripping means are connected rotatably to a cover which can be connected releasably to the electrode.

19. Detaching device according to claim 17,
wherein the stripping means comprise at least one strip with a stripping edge which is substantially parallel to the longitudinal axis of the electrode and can be brought into contact with the inner surface of the electrode.

20. Detaching device according to claim 16, characterized by collecting means for collecting the particles which have been stripped off.

21. Combination comprising
an electrostatic precipitator with at least one sleeve-shaped electrode, wherein the electrode is connected or can be connected releasably to a base part of the precipitator;
a detaching device for detaching particles from an inner surface of the electrode, wherein the detaching device contains stripping means for stripping the particles from the inner surface;
wherein the shape and size of the detaching device and of the electrode are coordinated with each other in such a manner that particles can be detached from an inner surface of the electrode by means of the detaching device.

22. Combination according to claim 21,
which comprises a spray dryer which contains the electrostatic precipitator.

23. Method for detaching particles from an inner surface of a sleeve-shaped electrode of an electrostatic precipitator, containing the following steps:
a) removing the electrode from the precipitator,
b) detaching particles from the inner surface of the electrode.

24. Method according to claim 23,
wherein,
before step a), the electrostatic precipitator is removed from a spray dryer,
the spray dryer contains an electrostatic precipitator with at least one electrode and at least one counter electrode,
the precipitator can be brought relative to the spray dryer into an operating position and into a removal position,
the electrodes and counter electrodes of the precipitator can each be supplied with an electric potential in the operating position, and
at least one electrode of the precipitator is separated or can be separated from the spray dryer in the removal position
